(19) United States
(12) Patent Application Publication
(10) Pub. No.: US 2019/0088014 A1
(43) Pub. Date: Mar. 21, 2019

(54) SURFACE MODELLING

(71) Applicant: Lancaster University Business Enterprises Limited, Lancashire (GB)

(72) Inventor: Daniel Richards, Lancaster (GB)

(21) Appl. No.: 16/083,541

(22) PCT Filed: Mar. 10, 2017
(86) PCT No.: PCT/GB17/50647

§ 371 Date: Sep. 10, 2018

(30) Foreign Application Priority Data
Mar. 10, 2016 (GB) 1604130.3

(51) Int. Cl. G06T 17/10; G06T 15/20

(52) U.S. Cl. CPC G06T 17/10; G06T 15/205

(57) ABSTRACT

A method of generating model data representing an object at a predetermined resolution, the method comprising: receiving data representing a surface of the object, the data representing the surface of the object as a function of a first parameter and a second parameter; receiving data defining a relationship between the first parameter, the second parameter and a third parameter, the third parameter defining a depth associated with the surface, and at least one property; wherein the first parameter, the second parameter and the third parameter define a volumetric space based upon the surface of the object; generating the model data representing the object based upon the data defining a relationship, the data representing the surface of the object and the predetermined resolution.

### TECHNICAL FIELD

The present invention relates to methods and apparatus for generating model data representing an object. More particularly, but not exclusively, the present invention relates to methods and apparatus for generating model data for the manufacture of an object.

### BACKGROUND OF THE INVENTION

Three dimensional objects can be designed and modelled in computer software prior to manufacture of the three dimensional object. An object may be designed using a Computer Aided Design (CAD) tool from which model data is output and the object may be manufactured using, for example, additive manufacturing using a 3D printer.

Various different representations of objects used by CAD tools are known. A common representation used by CAD tools to represent a three dimensional object is a boundary representation in which the outer surfaces of the object are modelled as connected polygon faces.

Two dimensional images known as texture maps may be mapped to the outer surface of the polygon model in order to give an object a certain material appearance. An extension of texture mapping is shell mapping in which further three dimensional polygon models may be mapped to the outer surface of the original object polygon model using a fixed geometric mapping to create three dimensional surface patterns.

Polygon models and boundary representations in general, however, result in hollow models that contain no information relating to the distribution of materials inside a three dimensional object. As such, whilst polygon models can provide data suitable for manufacture of objects using additive manufacturing, such model data is generally limited to a hollow shell, possibly with some texture and colour added to the surface.

Another representation of three dimensional objects used by CAD tools is voxel modelling. Whereas a two dimensional image may be represented through a two dimensional grid of dots known as pixels, a three dimensional object may be represented using a three dimensional grid of volumetric pixels known as voxels. Voxel modelling originated in the medical imaging field. For example, a CT scanner may take multiple scans of a part of the body such as the head, at multiple positions and angles in order to produce a set of cross-sectional slices. These slices can be composed to form a three dimensional volumetric model of the scanned part of the body.

Voxel models can be created for any object based upon cross-sectional scans of the object to generate a three dimensional voxel model. Voxel modelling may also be used for modelling volumetric data of designs of new three dimensional objects. For example, a voxel model may be generated based upon a geometric representation of an object, for example a boundary representation, by mapping the boundary representation of the object within a Cartesian grid of voxels. Any voxel that is within the boundaries of the object or is contact with a boundary surface is turned on. This creates a “voxelised” description of the object. A designer may then assign specific properties, such as material or colour, to each voxel and manufacture the object based upon the Cartesian voxel representation and the properties assigned to each voxel.

Voxel modelling however has limited scalability. Creating a large voxel grid is computationally expensive and can be inefficient given that every voxel in the voxel grid must be represented, even if a particular voxel is not turned on. As additive manufacturing hardware continues to improve at a pace to allow manufacturing at finer grain resolutions, voxel grid sizes capable of modelling such resolutions are becoming computationally challenging.

Furthermore, as voxel grid sizes grow, it becomes less and less practical for a designer to directly assign properties to each individual voxel. Storing properties on an individual voxel basis further contributes to the inefficiency and computational expense of voxel based modelling.

Functional representations have been used to define the shape and geometry of an object within a Cartesian voxel space. For example, a geometric primitive such as a sphere may be defined by a centre point and a radius such that all voxels within a radius of the centre point may be switched on in accordance with an equation of the sphere. Alexander Pasko, “Function representation in geometric modelling: concepts, implementation and applications”, The Visual Computer 11(8):429-446, 1995, discloses generation of geometric primitives inside Cartesian space and using Boolean operations and geometric modifiers to manipulate the created objects. Whilst, such methods can lead to interesting designs and is efficient in its encoding, it is hard for designers to create objects from scratch using mathematical equations.

Functional designs of objects have been automatically generated through a combination of a Compositional Pattern Producing Network (CPPN) and an evolutionary algorithm known as NeuroEvolution of Augmenting Topologies (NEAT).

A CPPN is a computational graph similar in structure to an Artificial Neural Network and comprises a network of nodes. Each node computes a simple computational function and the composition of nodes into an interconnected network allows any mathematical function to be represented. The CPPN can therefore be used to represent the mathematical function for the generation of objects.

The NEAT algorithm provides a means for automatically adjusting the structure of the CPPN based upon a specified objective. Further information can be found in Kenneth O. Stanley and Risto Miikkulainen, “Evolving Neural Networks through Augmenting Topologies”, Evolutionary Computation, 10(2):99-127, 2002 and Kenneth O. Stanley, “Compositional Pattern Producing Networks: A Novel Abstraction of Development”, Genetic Programming and Evolvable Machines Special Issue on Developmental Systems, 8(2):131-162, 2007. Jeff Clune and Hod Lipson, “Evolving three-dimensional objects with a generative encoding inspired by developmental biology”, Proceedings of the European Conference on Artificial Life, 141-148, 2011, describes use of CPPNs and the NEAT algorithm to automatically generate designs of three dimensional objects based upon a Cartesian voxel space. U.S. Pat. No. 8,982,149 B2 describes using a CPPN to generate two dimensional radial images based upon polar coordinates. These two dimensional radial images may be stacked in voxel space to create a representation of a three dimensional object.

Functional representations have also been used in conjunction with voxel modelling to define properties of each voxel in a compact form. In functional representations a property of a voxel may be defined by a mathematical function of the voxel's (x, y, z) location in the voxel grid. Encoding the properties of each voxel as a mathematical function has the advantage of compactness and efficiency.

There remains a need for improvements in modelling techniques, and in particular for improvements in the generation of model data for object manufacture.

### SUMMARY

According to a first aspect of the invention, there is provided a method of generating model data representing an object at a predetermined resolution, the method comprising: receiving data representing a surface of the object, the data representing the surface of the object as a function of a first parameter and a second parameter; receiving data defining a relationship between the first parameter, the second parameter and a third parameter, the third parameter defining a depth associated with the surface, and at least one property; and generating the model data representing the object based upon the data defining a relationship, the data representing the surface of the object and the predetermined resolution.

The first parameter, the second parameter and the third parameter may define a volumetric space based upon the surface of the object.

A volumetric space may be generated by extending the surface of the object, represented by a function of the first and second parameters, by a third parameter defining a depth associated with the surface. In other words, the surface of the object may act as a reference “plane” from which a third dimension may be added to generate a volumetric space.

In this way, given that the surface of the object has a particular shape and geometry, the volumetric space may also conform to the shape and geometry of the surface of the object to provide a surface conformed volumetric space. As such, model data may be generated from the volumetric space at a predetermined resolution in which the model data comprises a plurality of non-uniform, irregularly shaped voxels, unlike conventional voxelisation methods in which an object model may be mapped into a volumetric space comprising a plurality of uniform cubic voxels. Therefore, in prior art methods, conceptually, it may be considered that an object is forced to conform to the volumetric space instead of having the volumetric space conform to the object itself. The first, second and third parameters may define the shape and size of the volumetric space based upon the surface of the object.

The first, second and third parameters may define a volumetric space associated with the surface of the object such that model data defining a volumetric space can be generated based upon the surface of the object and properties may be associated with points of the volumetric space. By associating properties with points based upon first and second parameters defining a surface, the properties may be associated with points in the volumetric space based upon the surface itself. That is, by conforming the volumetric space to the surface of the object with which properties are associated, the model data more accurately represents the properties of the surface of the object. By comparison, in prior art methods, a property of the object may be associated with the closest voxel in a volumetric space that has not been generated based upon the surface of the object and its properties.

The surface of the object may be represented in any convenient functional way, for example as a Non-uniform rational B-spline (NURBS) surface.

The data defining a relationship may define a relationship between the first, second and third parameters, and a fourth parameter and the at least one property. The fourth parameter may be based upon a relationship between the first and second parameters. The fourth parameter may be a geometric property of the surface of the object. For example, the fourth parameter may be indicative of a curvature of the surface of the object. In this way, model data representing an object may be generated based upon a property of the surface of the object such that properties of the modelled object may be configured based upon the object itself.

The fourth parameter may in combination with the first, second and third parameters define the volumetric space based upon the surface of the object. For example, where the fourth parameter is indicative of the curvature of the surface of the object, the volumetric space may be curved based upon the curvature of the surface of the object.

The third parameter defining a depth associated with the surface may be based upon a relationship between the surface and a second surface. The second surface may be defined in any convenient way, for example as a further surface defined as a function of the first parameter and the second parameter or based upon the first surface. For example, the second surface may define a surface that is uniformly spaced from the first surface. The first, second and third parameters may therefore define a volumetric space relative to the surface defined by the first and second parameter. Generating properties associated with points in the volumetric space allows properties to be associated with points at the surface as well as points in a volume surrounding (i.e. above, below or both above and below) the surface such that complex three dimensional properties can be associated with the surface.

The data defining a relationship may be encoded as a Compositional Pattern Producing Network. The Compositional Pattern Producing Network may be generated based upon an evolutionary algorithm. The evolutionary algorithm may evolve complex relationships between surfaces and their properties that may be used to associate properties with new surfaces based upon a specified objective.

The at least one property may be selected from the group consisting of: thickness, material, colour, topology and geometric transformation. The at least one property may, for example, associate the presence or absence of material with points in a volumetric space, or may associate complex properties or combinations of properties at the points.

The at least one property may be a property associated with a plurality of values, wherein the property is determined based upon a probability associated with each of said plurality of values. In this way, properties may be associated with points in a volumetric space probabilistically. The at least one property may be generated based upon a probability associated with the property.

Generating the model data may further comprise receiving values for the first, second and third parameters. The first second and third parameters may be processed based upon the relationship to obtain a value for the at least one property. The values for the first, second and third parameters may be based upon the predetermined resolution. The predetermined resolution may correspond to display on a screen at a particular resolution or may correspond to a manufacturing process. It will be appreciated that the model data may be generated on demand for a desired resolution for a particular purpose. The functional surface and relationship therefore allows complex objects to be generated at different resolutions in a compact form.

The method may further comprise generating manufacturing data based upon the generated model data. Generating manufacturing data may further comprise generating data representing a plurality of two dimensional cross-sections of the object based upon the model data.

Generating the model data may comprise: generating first model data based upon a first resolution; generating a first cross section of the object based upon the first model data; and processing the first cross section to generate model data at a second resolution. The first resolution may be a relatively low resolution and the second resolution may be a relatively high resolution. For example, the first resolution may define a space comprising a first number of points and the second resolution may define a space comprising a second number of points greater than the first number of points.

Processing the first cross section to generate model data at a second resolution may comprise: determining a plurality of first voxels, each first voxel being associated with a point at which the object modelled at the first resolution is intersected by the cross section; generating a plurality of second voxels, wherein each first voxel is associated with a plurality of second voxels; and generating second model data based upon the plurality of second voxels.

Generating second model data based upon the plurality of second voxels may comprise: generating values of the first parameter, second parameter and third parameter based upon said plurality of second voxels; and processing the generated values based upon the data defining a relationship between the first parameter, the second parameter and a third parameter to determine the at least one property associated with each of the voxels.

The plurality of second voxels are therefore voxels associated with a higher resolution than the plurality of first voxels. The second voxels are only generated if they correspond to a voxel at the first, lower resolution. For example, the first voxels may be sub-divided to generate the second voxels. In this way, only relevant points (i.e. points that form a part of the object) are generated in the higher resolution. Model data representing the object including the at least one property may therefore be generated at a high resolution but with relatively low computational complexity.

The generated manufacturing data comprises data arranged to cause a manufacturing process to generate an object based upon the model data. The method may further comprise manufacturing an object based upon the manufacturing data. The manufacturing data may comprise a polygon model generated based upon the model data, or may comprise a plurality of cross sections of the object generated based upon the model data. Alternatively, the manufacturing data may be any suitable data arranged to cause the manufacturing process to generate the object. The manufacturing process may be an additive manufacturing process or may take any convenient form such as a subtractive manufacturing process.

The method may further comprise generating the data representing a surface of the object. For example, the data representing the surface may be generated by scanning a real-world object and processing data obtained from the scan to generate the surface.

The method may further comprise: receiving data representing a surface of a second object, the data representing the surface of the second object as a function of a first parameter and a second parameter; generating model data representing the second object based upon the data defining a relationship, the data representing the surface of the second object and the predetermined resolution. The data defining a relationship may therefore be used to associate one or more properties with multiple objects.

The invention may advantageously be used in the field of engineering design, for example, in the optimisation of mechanical properties such as shape optimisation, optimisation of multi-material compliant mechanisms and optimisation of functionally graded materials and machine parts. The invention may be applied in areas such as aerospace engineering, medical implants, prosthetics, sportswear and sporting equipment, automotive engineering and civil engineering.

Additionally, the invention may advantageously be used in the field of material science whereby the present invention allows objects to be manufactured at large scales and very small scales, for example, using nano-scale additive manufacturing or microfabrication. The invention allows the modelling of material and geometry such that new materials and composites may be explored and discovered.

The functional nature of the invention allows functions to be applied to different surfaces and generate structures with specific behaviours. For example, a function may generate certain geometric and material transformations in response to specific geometric properties of the surface. For instance, it may be desirable to respond to certain curvatures with a transformation to improve mechanical performance at points with that particular curvature. Additionally, other data may be input to the function such as finite element analysis data of the original surface geometry. A function may be generated to respond to such data by applying appropriate material and geometric transformations. Such functions may be reused and applied to other geometries to produce transformations appropriate to a specific object's geometry.

Furthermore, the invention may be used for creative design applications such as jewellery design, design of toys, design of decorative consumer products such as vases, the design of fabrics and the like. The invention allows easy mass customisation of consumer products. Consumers may exploit the “on-demand manufacturing” nature of fabrication technology to produce objects with bespoke designs.

Aspects of the invention can be combined and it will be readily appreciated that features described in the context of one aspect of the invention can be combined with other aspects of the invention.

It will be appreciated that aspects of the invention can be implemented in any convenient form. For example, the invention may be implemented by appropriate computer programs which may be carried on appropriate carrier media which may be tangible carrier media (e.g. disks) or intangible carrier media (e.g. communications signals). Aspects of the invention may also be implemented using suitable apparatus which may take the form of programmable computers running computer programs arranged to implement the invention.

### BRIEF DESCRIPTION OF THE DRAWINGS

Embodiments of the invention will now be described, by way of example, with reference to the accompanying drawings, in which:

FIG. 1 is a schematic illustration of a system for generating model data representing an object according to an embodiment of the present invention;

FIG. 1A is a schematic illustration of a computer of the system of FIG. 1 in more detail;

FIG. 2 is a flowchart showing processing carried out for generating model data representing an object;

FIG. 3A is a schematic illustration of an example three dimensional object;

FIG. 3B schematically illustrates the sphere of FIG. 3A converted into a NURBS surface;

FIG. 3C schematically illustrates the surface of FIG. 3B defined with an additional depth;

FIG. 4 schematically illustrates portions of model data generated at different resolutions;

FIGS. 5A and 5B schematically illustrate a volumetric space defined based upon a first surface and a second surface;

FIGS. 6A and 6B each schematically illustrates an example CPPN;

FIG. 7 is a schematic cross sectional view of part of a surface having a space defined normal to the surface by a third parameter defining a depth W;

FIG. 8 is a schematic cross sectional view of part of a surface having a variable material composition;

FIG. 9 is a schematic illustration showing probabilistic material deposition;

FIG. 10 is a schematic cross sectional view of part of a surface having a topology in which material is variably deposited;

FIG. 11 is a schematic illustration of part of a UVW shell discretized into a three dimensional grid of voxels at a particular resolution;

FIG. 12 is a schematic illustration of the model of FIG. 9 converted to a polygon mesh;

FIG. 13 is a flowchart showing processing carried out for generating manufacturing data based upon the model data;

FIGS. 14A-14G schematically illustrate the processing carried out in FIG. 13.

FIGS. 15A-15F provide a further schematic illustration of the processing carried out in FIG. 13;

FIGS. 16A-16F provide an alternate view of the schematic illustrations of FIGS. 15A-15F;

FIGS. 17A and 17B provide an alternate view of the schematic illustrations of FIGS. 14F and 14G.

### DETAILED DESCRIPTION

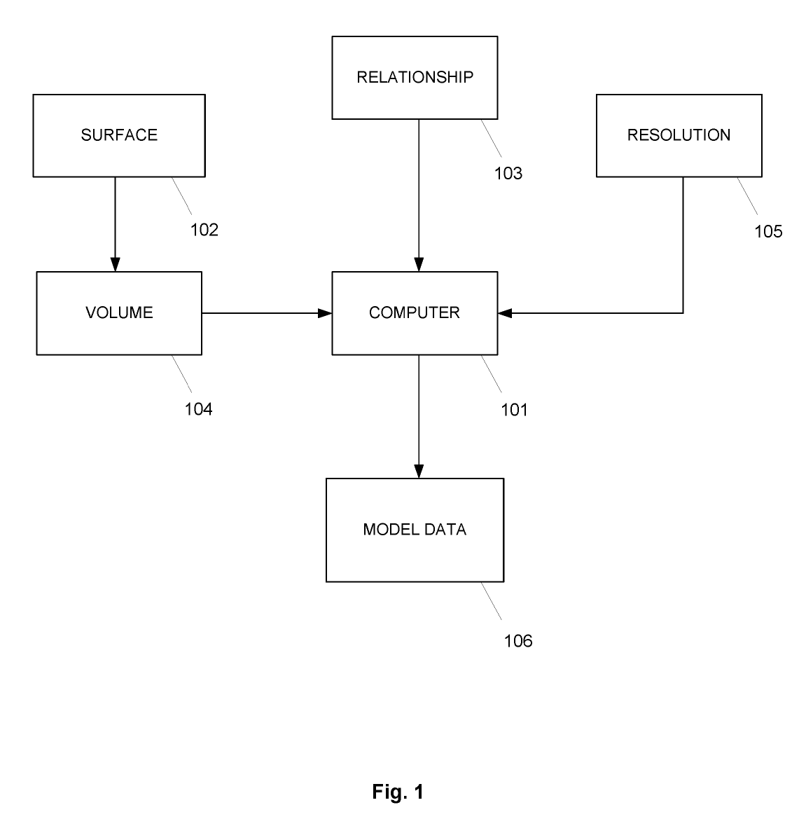

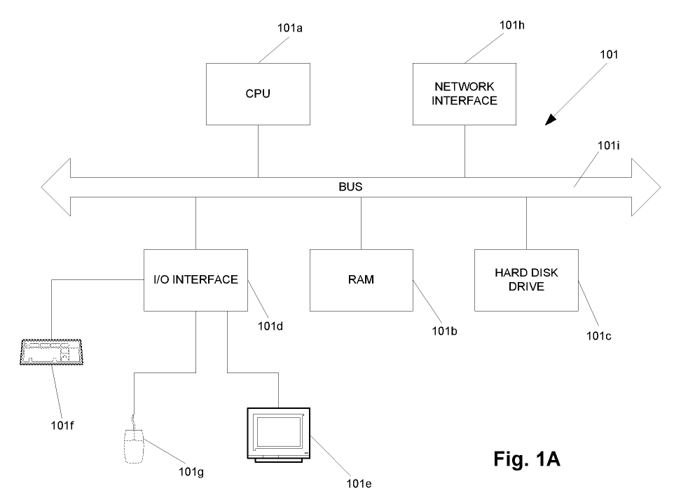

Referring now to FIG. 1, a computer 101 is arranged to receive data 102 representing a surface of a three dimensional object for which model data is to be generated. The data 102 represents the surface of the object as a function of first and second parameters and may be, for example, a Non-uniform rational B-spline (NURBS) representation.

The computer 101 is further arranged to receive data 103 defining a relationship between a volume 104 defined based upon data 102 representing a surface of the three dimensional object and at least one property. Volume 104 is a surface-conformed volumetric space defined by the addition of a depth to the surface 102 and allows the surface represented by data 102 to be processed in three dimensions. The data 103 defining a relationship provides a function that maps points within volume 104 to properties. The relationship therefore defines a relationship between first and second parameters associated with the surface and a third parameter associated with a depth of the volumetric space, and at least one property.

The computer 101 is further provided with an input resolution 105 defining a resolution for the model data to be generated. The input resolution may, for example, be data stored at the computer defining a resolution required for output model data 106, or may be provided as input by a user. The input resolution may be associated, for example, with an on-screen resolution for display of an object or a manufacturing resolution for a specific machine resolution to manufacture an object.

The data 102 representing a surface, data 103 defining a relationship between a volume defined based upon the surface and at least one property and input resolution 105 are processed by the computer 101 to generate model data 106. The model data 106 represents an object at the input resolution 105 that is based upon the object associated with the received data 102, but is modified based upon at least one property defined by the received data 103 defining a relationship.

By modifying a volume 104 defined based upon the data 102 representing a surface of a three dimensional object such that a depth is effectively added to the surface of the object, more complex surface features may be modelled and modelling of intricate designs and embossed patterns is possible. In addition, more complex modelling of the material of the surface is permitted. For example, the material of the surface may be built from layers of different material or may be a combination of different materials. Other properties of the surface may be modelled advantageously with the present invention.

Whilst such modelling of a thickness of an object is theoretically possible using a Cartesian voxel space, by representing the surface of the object as a function and modifying a volume defined based upon the functional representation of the surface using a relationship between the volume and at least one property, the modelling can be performed automatically based upon properties of the volume in an efficient way. Furthermore, the functional representation and the relationship provide a compact definition of the object and property that can be used to generate model data at any provided resolution as discussed in detail below.

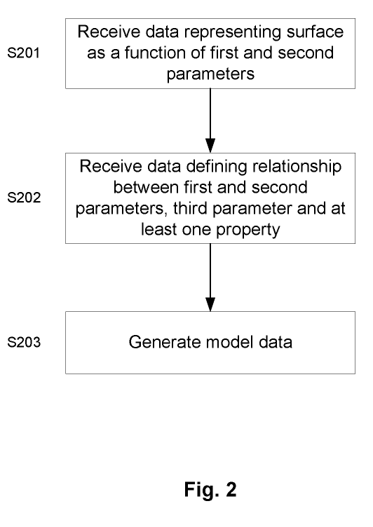

The processing performed by the computer 101 is described in further detail below with reference to FIG. 2.

FIG. 1A shows the computer 101 of FIG. 1 in further detail. It can be seen that the computer 101 comprises a CPU 101a which is configured to read and execute instructions stored in a volatile memory 101b which takes the form of a random access memory. The volatile memory 101b stores instructions for execution by the CPU 101a and data used by those instructions. For example, in use, the received functional representation of the surface 102 may be stored in volatile memory 101b.

The computer 101 further comprises non-volatile storage in the form of a hard disc drive 101c. For example, the data 102 representing the surface and data 103 defining a relationship between a volume and at least one property may be stored on the hard disc drive 101c. The computer 101 further comprises an I/O interface 101d to which are connected peripheral devices used in connection with the computer 101. More particularly, a display 104e is configured so as to display output from the computer 101. The display 104e may, for example, display the functional representation of the surface 102 or the generated model data 106 at a particular display resolution. Input devices are also connected to the I/O interface 101d. Such input devices include a keyboard 101f and a mouse 101g which allow interaction with the computer 101. Other input devices may also include gesture-based input devices. A network interface 101h allows the computer 101 to be connected to an appropriate computer network so as to receive and transmit data from and to other computing devices. The CPU 101a, volatile memory 101b, hard disc drive 101c, I/O interface 101d, and network interface 101h, are connected together by a bus 101i.

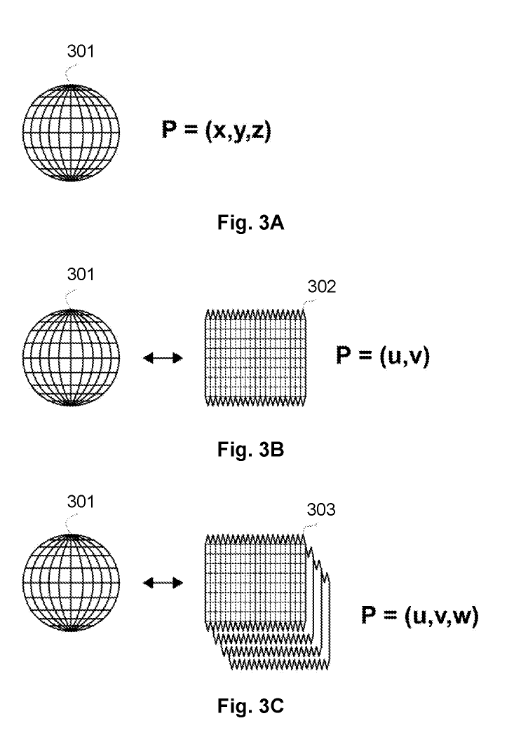

Referring now to FIG. 2, processing to generate model data representing an object is shown. At step S201, data representing a surface of the object as a function of a first parameter and a second parameter is received. Such data may be a NURBS representation of the surface as is known in the art, and as described in further detail below with reference to FIGS. 3A to 3C.

At step S202, data defining a relationship between the first parameter, the second parameter and a third parameter, the third parameter defining a depth associated with the surface, and at least one property is received. The first parameter, second parameter and third parameter together define a volumetric space defined based upon the surface. The data defining a relationship between the first parameter, the second parameter and the third parameter, and the at least one property provides a functional definition of a relationship between points in the volumetric space and the at least one property.

The at least one property may for example be a material, a colour, a thickness or any other suitable property. The relationship may for example be a function mapping each point in the volumetric space to a corresponding value for the at least one property.

At step S203, model data representing the object is generated based upon the data defining the relationship, the data representing the surface of the object and a predetermined resolution. As previously described, the resolution may be determined based upon an on-screen resolution for display of the model data or the resolution may be determined based upon a manufacturing resolution for a specific machine resolution to manufacture the object. The model data generated at step S203 represents an object corresponding to the object associated with the surface data received at step S201 in which a surface of the object is modified based upon the property associated with the data received at step S202.

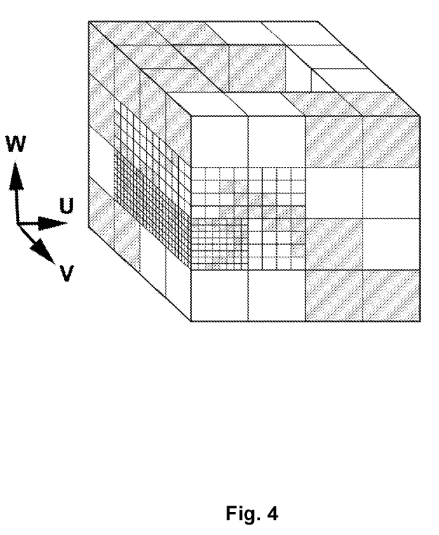

The data defining a surface and data defining a relationship may be stored and processed based upon any provided resolution such that model data is generated at a the provided resolution. In this way, model data may be generated at a provided resolution in real-time. It will be appreciated that the predetermined resolution need not be uniform across the model. Model data for a first portion of the model may be generated at a first resolution whilst model data for a second, different portion of the model may be generated at a second resolution, as shown in FIG. 4. This allows for some parts of the model to be generated in a finer resolution if for example, more detail is required at a particular part of the model.

FIGS. 3A to 3C schematically illustrate the spaces described in the processing of FIG. 2. Referring first to FIG. 3A, a schematic illustration of an example three dimensional object 301 is shown. The object depicted in FIG. 3A is a simple sphere. It should be noted that the processing performed by the invention would be equally applicable to three dimensional objects with more complex geometry. A point P on the sphere may be defined by a set of Cartesian co-ordinates (x, y, z) as shown in FIG. 3A. Objects to be modelled may be created in any convenient way, for example by a designer using a CAD software tool or through generation as a result of a three dimensional scan of a real-world object or other suitable method.

FIG. 3B illustrates the sphere 301 of FIG. 3A converted into a NURBS surface 302 in a UV co-ordinate space. As shown in FIG. 3B, a point P on a NURBS surface is defined by a function of relative (u, v) co-ordinates. The UV co-ordinate system may, for example, be scaled such that u and v are continuous real numbers between −1.0 and 1.0 with the centre of the surface located at (0.0, 0.0), although any appropriate range may be used. The NURBS surface therefore represents the surface as a function of a first and second parameter.

FIG. 3C illustrates the surface 302 of FIG. 3B defined with an additional depth. Conceptually, the representation of FIG. 3C is the UV surface of FIG. 3B extended by a dimension W to define a volumetric space 303 around the UV surface such that each point on the surface of FIG. 3B has an additional depth component in FIG. 3C. The representation of FIG. 3C therefore can be processed to modify points associated with the surface of FIG. 3B in a third dimension. The representation of FIG. 3C provides a functional representation of a UVW shell defined relative to the surface of FIGS. 3A and 3B. Dimension W may also extend between a range −1.0 and 1.0 and may be a real and continuous number.

The third parameter may define an additional depth that is defined in any convenient way. For example, the third parameter may define a depth a uniform distance from the surface. Alternatively, the depth component may be defined relative to a surface normal at each point on the UV surface. In some embodiments the depth component may be defined relative to a modified UV surface, for example a depth of the surface may be defined relative to a further UV surface defined based upon a property of the initial UV surface.

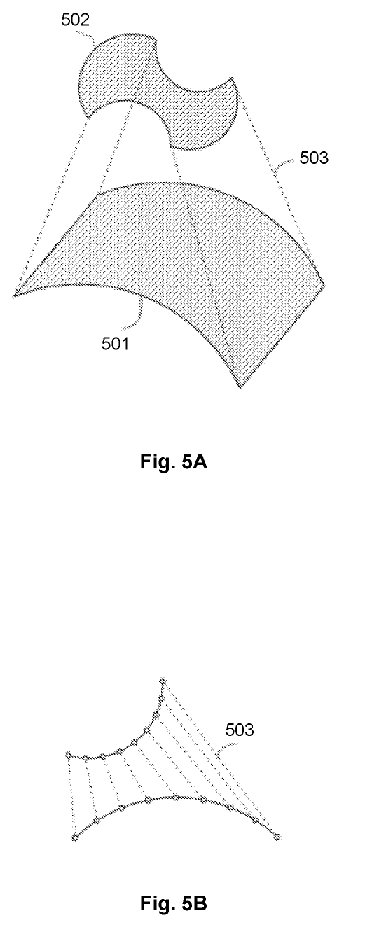

Alternatively, the third parameter and the additional depth may be defined based upon a first UV surface 501 and a second UV surface 502 defined relative to the first UV surface as shown in FIG. 5A. The second UV surface may define an upper boundary of a volumetric space (UVW shell) surrounding the first UV surface. The third parameter may define a dimension W 503 of the UVW shell that represents a relative depth and position in the UVW shell between the first and second UV surfaces. For example, W may be defined in a range −1.0 and 1.0, with a value of −1.0 representing a position at the first UV surface and a value 1.0 representing a position at the second UV surface. A value of 0.0 may represent a mid-point between the first and second surfaces. In this way, the first and second surfaces may, for example, be used to define a maximum depth at points on the surfaces.

The directions of the UV co-ordinate systems of the first and second surfaces may be aligned. This may, for example, be achieved by designing the first and second surfaces in a Cartesian space with the second surface located at a desired height above the first surface. The first and second surfaces may be converted to a UV surface representation. The distance between corresponding (u, v) points on the first and second surfaces in Cartesian space may be converted to a relative W dimension 503 scaled in the range −1.0 and 1.0 as described above and shown in FIG. 5B.

Whilst the above has been described in relation to a first surface and a second surface, it will be appreciated that any number of surfaces may be used. For example, a third surface may be located above the second surface such that the third surface now defines the upper boundary of the volumetric space. The W dimension may then be scaled such that a value of −1.0 represents a point on the first surface, a value of 0.0 represents a point on the second surface in between the first and third surface and a value of 1.0 represents a point on the third surface. The W dimension may also be defined using a plurality of Bezier curves linking corresponding points between the first, second and third surfaces. In this way, the volumetric space may be based upon a plurality of layers of UV surfaces.

It will be appreciated that the third parameter may define an additional depth that extends above the UV surface or below the UV surface, or both above and below the UV surface. Extensions may cause the outer surface defined by the additional depth to have a shape different to that defined by the surface.

The data 102 representing the surface of the object received at step S201 may be generated at the computer 101 or may be received from an external source. The data 102 may, for example, be generated based upon a user defined boundary representation of a three dimensional object, such as a polygon mesh, and the user defined boundary representation may be converted at the computer 101 to a functional representation such as a NURBS surface representation, as can be carried out by a typical CAD software package. Alternatively, the data 102 may be generated based upon scan data obtained from a scanning device as known in the art. The scanned data may provide a plurality of points and processed to generate a NURBS surface.

Given that the UVW shell is an extension of the original surface itself, modifying the UVW shell based upon at least one property allows the shell to be modified based upon the object itself, that is, the shape and form of the object rather than being simply based upon arbitrary points in a Cartesian space. Furthermore, the functional relationship allows properties to be encoded in a compact form at an infinite resolution to enable model data to be generated according to any resolution.

Whilst the above has been described in terms of a NURBS representation of the surface, it will be appreciated that any other suitable functional representation may be used. For example, whilst it is described above that a UV surface is provided and extended in a third dimension, in some embodiments a surface may be defined as a function of three or more parameters and a third dimension may be defined relative to the surface using a further parameter.

Additionally or alternatively the relationship between the first, second and third parameters and the at least one property may be based upon a fourth parameter associated with the first, second and third parameter. For example, whilst the first, second and third parameters may provide a location in the UVW shell, the fourth parameter may correspond to a surface curvature K of the surface at a point in the UVW shell. Where the UVW shell is defined based upon first and second UV surfaces as described above, the surface curvature of either the first or the second UV surface may be used, or a combination of both first and second surface curvatures may be used.

Where surface curvature is used, the surface curvature K at a point (u, v) may be extracted by comparing the difference between the angle of the surface normal at point (u, v) and its surrounding points, such as a Moore neighbourhood of the point (u, v). The surface curvature K is therefore a function of the first and second parameters, that is, K(u, v).

The surface curvature K(u, v) may be mapped to a range between −1.0 and 1.0, where −1.0 represents the smallest change in angle in the entire surface, that is, the least curvature, and 1.0 represents the largest change in angle in the entire surface, that is, the most curvature. Alternatively, absolute curvature values may be used.

It will be appreciated that different methods of extracting the surface curvature and different scales for representing the surface curvature may be employed as deemed appropriate by a person skilled in the art. It will also be appreciated that the fourth parameter may be based upon other geometric properties of the surface or that the fourth parameter may be a parameter that is unrelated to the surface such as time.

The relationship between the parameters and the at least one property may be defined as a functional relationship between the parameters and the at least one property. The functional relationship may, for example, be encoded as a Compositional Pattern Producing Network (CPPN). A CPPN is a computational network similar in structure to an Artificial Neural Network and parametrically defines a function. A CPPN comprises a set of input nodes and output nodes. The set of input nodes represents the data input to the function and the set of output nodes represents the output of the function.

A CPPN typically comprises a plurality of interconnected processing nodes between the input nodes and output nodes. Each processing node has at least one input and an associated weight for that input. The node computes the weighted sum of its inputs and applies a simple function, known as an activation function, to the weighted sum. The activation function may for example be a sine, cosine, Gaussian or sigmoid function amongst others. The resulting value after application of the activation function forms the output of the node which may in turn be an input of another node.

A CPPN therefore comprises a composition of nodes that compute simple functions that allows complex mathematical functions to be represented. By adjusting the number of nodes, the connections between nodes, the activation function of each node and the weights of the inputs to each node, different mathematical functions may be obtained.

Whilst a CPPN may be designed manually, CPPNs can be automatically generated and optimised using an evolutionary algorithm such as NeuroEvolution of Augmenting Topologies (NEAT) as disclosed in Kenneth O. Stanley and Risto Miikkulainen, “Evolving Neural Networks through Augmenting Topologies”, Evolutionary Computation, 10(2):99-127, 2002 and Kenneth O. Stanley, “Compositional Pattern Producing Networks: A Novel Abstraction of Development”, Genetic Programming and Evolvable Machines Special Issue on Developmental Systems, 8(2):131-162, 2007, which are incorporated herein by reference. The NEAT algorithm begins with a network consisting only of input nodes connected to output nodes. The algorithm proceeds iteratively, and upon each iteration, new nodes may be inserted and connections between nodes may be modified. Over time, the complexity of the network grows and may be optimised with respect to specified performance objectives.

The NEAT algorithm may therefore be used to generate a CPPN that is capable of providing a predetermined property to an object based upon properties of the object itself. For example, the NEAT algorithm may be used in a shape optimisation problem to generate surfaces with suitable properties such as load-bearing properties, compliant mechanisms or aerodynamic properties.

In general terms, the NEAT algorithm initialises a set of random CPPNs comprising an input layer and an output layer of nodes. The inputs may correspond to properties of the object itself such as its geometry. The output may correspond to the predetermined property. Every node in the input layer is connected to every node in the output layer with a randomly weighted connection. Each initial CPPN defines a random relationship between the object and the predetermined property.

The initial CPPNs are evaluated against a predetermined objective function. For example, an object with properties defined by a particular CPPN may be simulated with finite element analysis to evaluate the object's resistance to deformation under simulated loads, or the object may be simulated with fluid dynamics to evaluate the object's aerodynamic properties. Each initial CPPN may be ranked based upon the evaluated objective function.

A new set of CPPNs may be generated based upon the initial CPPNs and the rankings to replace the initial set of CPPNs. The NEAT algorithm may generate new replacement CPPNs based upon a combination of operations. For example, the best ranked CPPNs may be simply be left unaltered, or a CPPN may undergo a slight modification known as a mutation operation, or two highly ranked CPPNs may be merged together in an operation known as cross-over. Further details of such operations may be found in the above referenced documents.

The replacement set of CPPNs may be evaluated against the objection function in the same manner and a further set of CPPNs may be generated to replace the current set. In this way, better performing CPPNs may be generated upon each iteration of the algorithm. The algorithm repeats until a predetermined stopping criterion such as a total number of iterations or a criterion based upon the objective function is satisfied.

The NEAT algorithm outputs a CPPN or a set of CPPNs that best satisfies the objective function. In this way, the NEAT algorithm may be used to generate a CPPN that is capable of providing a predetermined property to an object based upon properties of the object itself.

For example, the NEAT algorithm may take as input any of parameter U, V, W or any input based upon any of parameter U, V, W such as curvature K(u, v). Based upon these inputs, the NEAT algorithm may output a CPPN encoding a relationship between the inputs and at least one property for the surface.

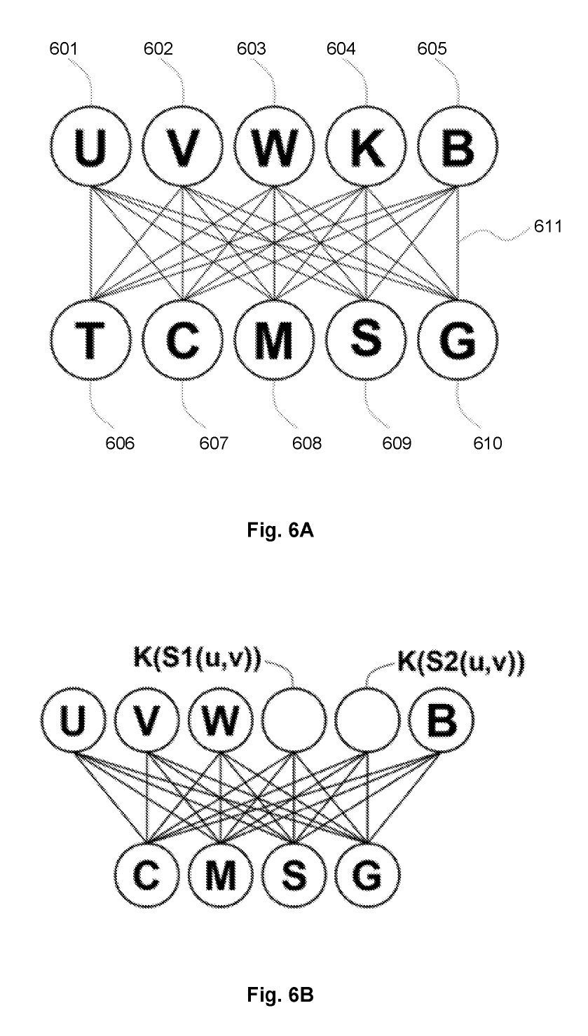

FIG. 6A schematically illustrates an example CPPN. The CPPN shown in FIG. 6A comprises input nodes 601, 602, 603 associated with parameters u, v and w, an input node 604 representing surface curvature K(u, v) and a bias node 605, B, which may, for example, provide a constant input value of 1 to all other nodes. Where the UVW shell is defined based upon first and second UV surfaces as described above, the CPPN may have an input node representing the surface curvature of the first UV surface K(S1(u,v)) and an input node representing the surface curvature of the second UV surface K(S2(u,v)) as shown in FIG. 6B.

The CPPN comprises a set of output nodes 606, 607, 608, 609, 610 that each represents a desired property of the object to be modelled. The input values are fed through the CPPN to obtain values for each property of the object for that particular set of input values. For simplicity, the CPPN depicted in FIG. 6A, only comprises a set of input nodes connected to a set of output nodes through weighted connections 611. It will be appreciated that the CPPN may further comprise a plurality of nodes between the input and output nodes.

The CPPN may be generated to provide outputs corresponding to properties of any desired form, for example by evolving the CPPN using a NEAT algorithm to provide such properties based upon the volumetric space. The property may be any suitable property associated with a surface of an object such as, for example, a local thickness T, colour C, material composition M, topology S and geometric transformations G. Alternatively or additionally a combination of properties may be associated with a surface using a single CPPN such as the CPPN of FIG. 6A.

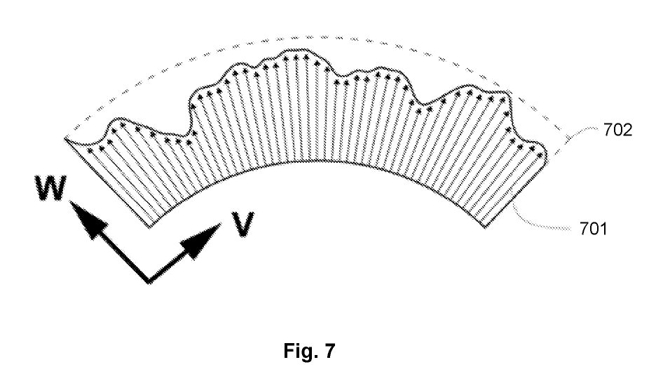

An example cross sectional view of part of a surface having a space defined normal to the surface by a third parameter defining a depth W 701 is illustrated in FIG. 7. The processing described above allows a local thickness property T to be associated with points in the UVW shell 702 to define a local thickness associated with each point on the surface.

A colour property may define the colour for each point within the UVW shell. Depending on the colour scheme required, the colour property may comprise a plurality of output nodes. For example, for full colour designs in RGB, HSB, HSL or HSV colour spaces, one output node per channel may be used, outputting real numbers in the range 0.0 and 1.0 (or in the range 0 to 255 for RGB values). For monochrome designs, a single output node outputting integer values in the range 0 to 255 may be sufficient.

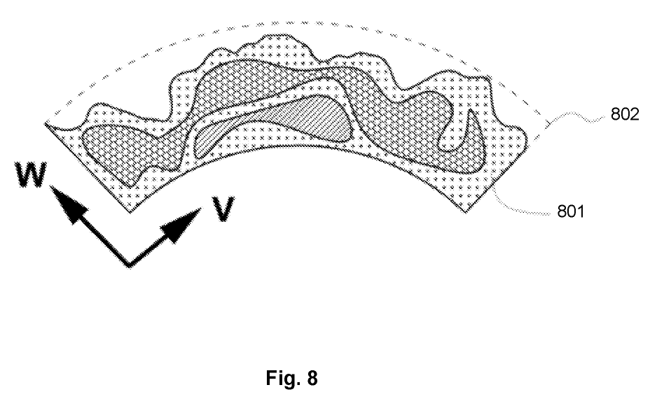

A material composition property may define the material properties 801 of each point in the UVW shell 802 enabling each point to have its own material composition specified as illustrated in FIG. 8. The definition of material properties may be dependent on the manufacturing process used to manufacture the object.

For example, in a manufacturing process whereby materials are blended, e.g. by combining different concentrations of base resins in additive manufacturing, material properties may, for example, be represented by one or more output nodes as continuous values between 0.0 and 1.0 in which the values represent the proportion of a particular material associated with a point in the space.

Where a 3D printer has the ability to blend two or more base materials (i.e. filaments), for example, in a single shared print head, the output nodes may define a ratio of materials at a particular point (u, v, w). This ratio may define how fast different materials are fed into the shared print head of the 3D printer. For example, a CPPN may have two output nodes, each output node associated with a respective material. The output nodes may be arranged to output values that sum to 1.0, with each of the output nodes providing an indication of the proportion of each material for a point in space.

In manufacturing processes that combine a finite number of discrete materials, a single output node may be used that outputs a real number between 0.0 and 1.0. The output range may be divided into sub-ranges with a sub-range associated with one of the available materials. If the output value is within a sub-range associated with a particular material, that material is selected for the corresponding point in the volumetric space. For example, where three materials are available, the material at a point (u, v, w) with curvature K(u, v) may be selected based upon:
M(u, v, w, K(u, v))=M1, if M<=⅓; M2, else if M<=⅔, M3 otherwise
   whereby M1, M2, M3 are the three available materials for selection and M is the value of the output node. The sub-ranges for each material may be adjusted to increase or decrease the likelihood of selecting a material in order to create an object of a certain material composition. It will be appreciated that the above method may be used for any number of materials and is not limited to three materials as described in the example above.

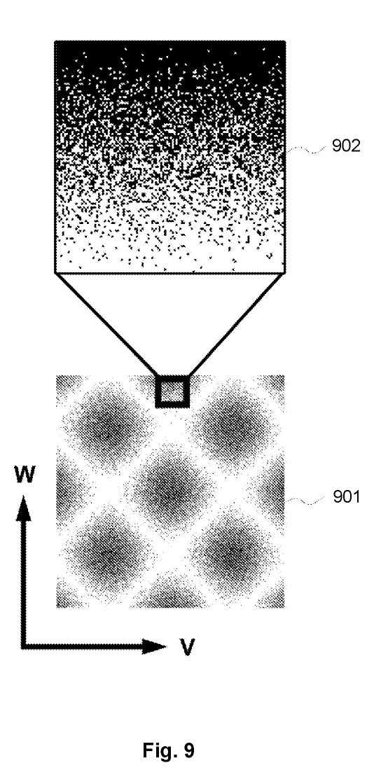

In a manufacturing process using functionally graded materials, whereby discrete blocks of materials are combined at small scales to create a seamless material, the material output node may be used to define a probabilistic material deposition 901, 902 as shown in FIG. 9. For example, the material at a point (u, v, w) with curvature K(u, v) may be selected according to the following scheme:
M(u, v, w, K(u, v))=M1, if random(0, 1)<=M; M2 otherwise
   whereby M1 and M2 are two different available materials, M is the value of the output node and random(0, 1) is a real number between 0.0 and 1.0 that is generated at random. The value M may define a probability that a point (u, v, w) with curvature K(u, v) has material M1. For example, a value M=0.9 signifies a 90% probability that M1 will be selected and 10% probability that M2 will be selected. A number may then be generated based upon the probabilities associated with different materials such that the number determines the material for a particular input. It will be appreciated that the value of M may be different for each set of inputs to the CPPN such that the likelihood of a particular material being deposited may be different for different locations.

Whilst a probabilistic output node has been described in the context of the material output node, it will be appreciated that other properties may also be defined using a probabilistic output.

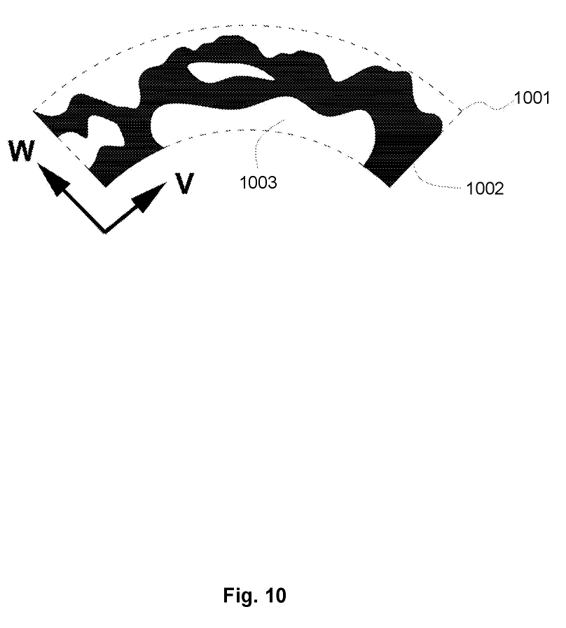

A topology property S may define whether a particular point in the UVW shell 1001 is solid 1002 and should have material deposited at that point or is void 1003 and should not have material deposited at that point. A cross sectional surface having a topology in which material is variably deposited at points is shown in FIG. 10. By defining the surface topology in this way, complex 3D surface features may be modelled and created. The value of the topology property may be between 0.0 and 1.0 and a predetermined threshold may be used to determine if a point is solid or void. The threshold may also be adjusted in real-time to manipulate the topology of the surface as required.

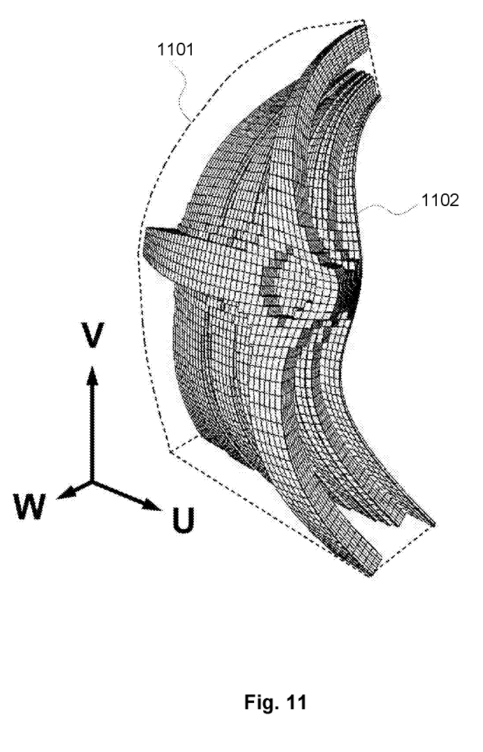

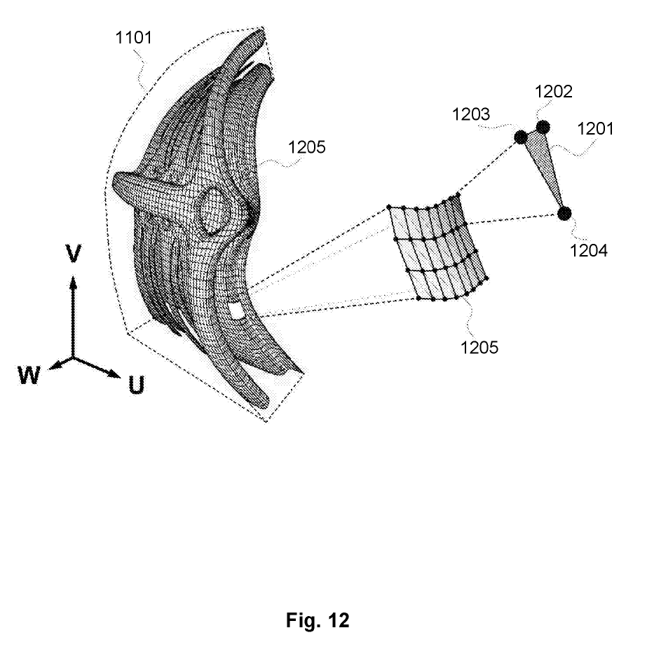

A geometric transformations property G may define properties related to model data generated in the form of a polygonal model. In some manufacturing processes, mesh-based fabrication instructions are required. In general terms, a polygon mesh may be generated by discretizing the UVW shell 1101 into a three dimensional grid of voxels 1102 at a particular resolution as shown in FIG. 11. The outer faces of all voxels may then be converted into polygon faces 1201 with vertices 1202, 1203, 1204 to create a polygon mesh 1205 as shown in FIG. 12.

Additional mesh-based geometric manipulations may be applied to the polygon model. For example, the mesh may be smoothed using techniques such as Laplacian smoothing. In conventional Laplacian smoothing, a vertex is moved to a new position based upon an average of the vertex's current location and the location of neighbouring vertices. The geometric transformations property G may define a local smoothing weight to be applied to each vertex such that a weighted Laplacian smoothing may be performed. For example, the new vertex location obtained from conventional Laplacian smoothing and the original vertex location may define a direction in which the original vertex is to be moved. The property G may define how far in that direction the original vertex is to be moved and thus a new weighted vertex location can be defined.

Other geometric properties that may be represented as an output of the CPPN may for example include, aperture size in each polygon face, procedural subdivisions or other surface-based shape transformations.

In an embodiment, the relationship between the parameters and the at least one property may be represented by a CPPN that has been automatically generated using the NEAT algorithm. The automatically generated CPPN may be further adjusted manually by manipulating the weights associated with inputs, creating new weighted connections between nodes, creating new nodes or removing existing nodes.

The CPPN may also be manually adjusted in an interactive mode. For example, a graphical representation of the model may be displayed on a screen. A user may interact with the graphical representation of the model to adjust the properties of the surface which in turn adjusts the CPPN appropriately to reflect the desired changes.

As described above, model data representing an object may be generated using the methods discussed above. The model data may be used to manufacture the object represented by the data. Additive manufacturing processes typically require object data based upon a conventional Cartesian voxel space such that model data is required to be generated at a particular manufacturing resolution and converted to a Cartesian representation. For example, manufacturing data may comprise a set of two dimensional Cartesian slices of the model in UVW space. The two dimensional Cartesian slices may be stacked to form a three dimensional Cartesian model of the object that can be used in a manufacturing process.

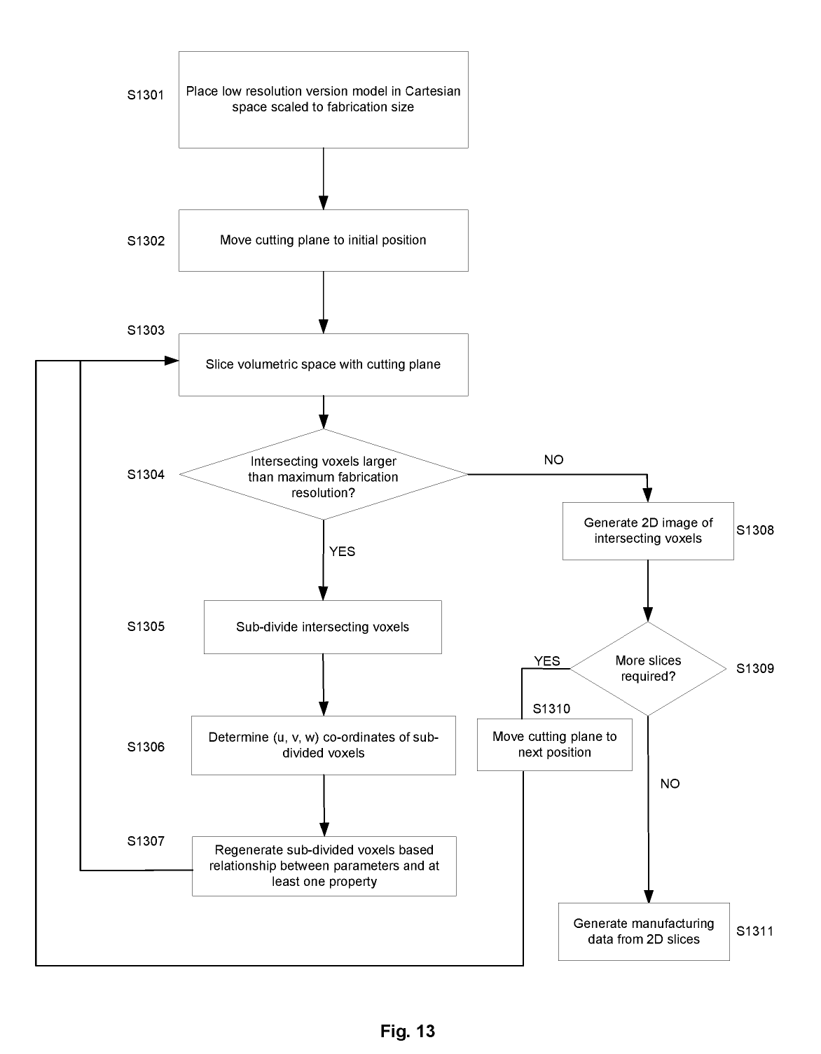

Referring now to FIG. 13, processing for generating manufacturing data based upon model data generated according to FIG. 2 is shown. At step S1301, a low resolution version of the functional surface-conformed volumetric space is generated and output as a plurality of voxels in Cartesian space such that the object is scaled to actual fabrication size. Each vertex of the plurality of voxels is located at a particular (u, v, w) co-ordinate based upon the discretization of the volumetric space into voxels. The corresponding Cartesian (x, y, z) co-ordinate for each voxel vertex may be computed based upon the original NURBS surface using methods known in the art.

At step S1302, a first Cartesian slice is obtained from the object in the Cartesian space based upon a two dimensional cutting plane through the object in the Cartesian space. It will be appreciated that such a Cartesian slice can be obtained using modelling techniques in a computer of the Cartesian space. By using a low resolution version in the first instance such modelling is relatively computationally inexpensive. A typical low resolution may be approximately 30×30×5 in the U, V, W dimensions respectively. However, it will be appreciated that an appropriate low resolution will typically depend upon properties of the model.

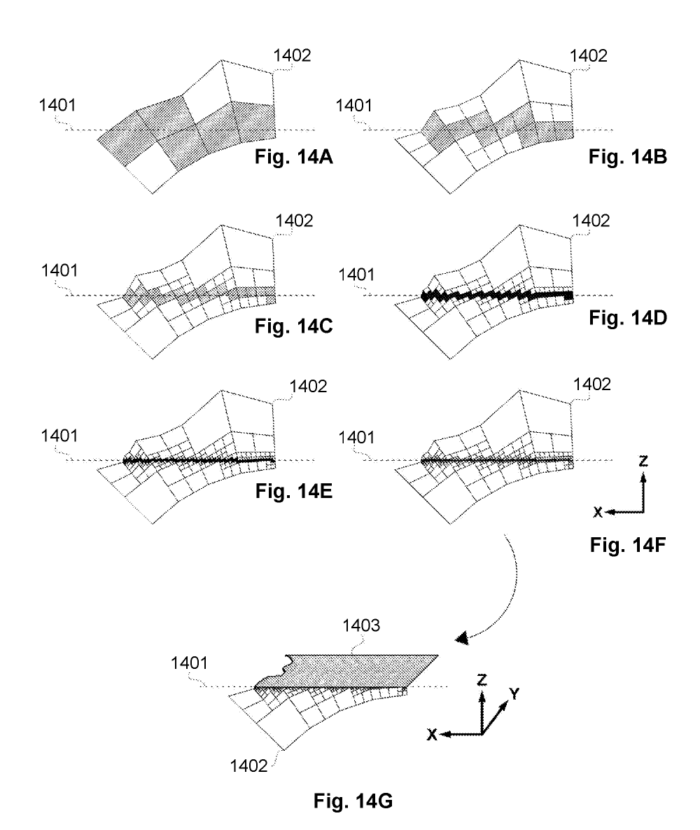

At step S1303, the cutting plane 1401 slices the volumetric space 1402, intersecting a plurality of voxels of the surface in Cartesian space as shown in FIG. 14A. At step S1304, a test is performed to determine if any of the intersecting voxels have a dimension that is larger than the fabrication resolution of the manufacturing process.

If it is determined that any of the intersecting voxels are larger than the fabrication resolution of the manufacturing process, at step S1305, the intersecting voxels that are larger than fabrication resolution are sub-divided into smaller voxels as shown in FIG. 14B. For example, a voxel may be sub-divided uniformly into eight sub-voxels.

At step S1306, the (u, v, w) co-ordinates of the sub-divided voxels are determined based upon the method of sub-division. For example, if a voxel is sub-divided uniformly into eight sub-voxels, the co-ordinates of each sub-voxel simply correspond to the mid-points between the vertices of the original voxel in each UVW direction. The Cartesian co-ordinates of each sub-voxel may be determined in a similar manner.

At step S1307, the surface at the sub-divided voxels is regenerated by querying the functional relationship between the points in the UVW shell and the at least one property based upon the determined (u, v, w) co-ordinates for the sub-divided voxels. Processing then returns to step S1303 to re-slice the volumetric space and the sub-divided voxels. The processing of steps S1303 to S1307 is repeated to iteratively generate voxel spaces as illustrated in FIGS. 14C to 14F until it is determined at step S1304 that the intersecting voxels correspond to the required resolution for fabrication and processing passes to step S1308. Alternatively or additionally, processing may pass from step S1304 to step S1308 if the number of iterations exceeds a predetermined threshold.

At step S1308 a cross sectional plane through the object is generated of the intersecting voxels of the generated voxel space. An example of a cross sectional plane is shown in FIG. 14G. The cross sectional plane provides a cross section 1403 of the object indicating at least one property of the object for each voxel in the cross section. For example, the cross sectional plane may indicate whether material should be deposited at each voxel in the cross sectional plane. Additionally or alternatively, the cross sectional plane may indicate properties such as colour or material composition of each voxel in the plane.

At step S1309, a test is performed to determine whether any further two dimensional slices are to be generated. If further two dimensional slices are required, the cutting plane is moved to a next position at step S1310 and processing returns to step S1303 where a further cross sectional plane is obtained and the processing of steps S1303 to S1308 is performed to generate a subsequent cross sectional plane. It will be appreciated that each cross sectional plane provides a layer of an object that can be used by an additive manufacturing process to create a layer of the object. Each cross sectional plane may, for example, be a single voxel depth plane of the printing resolution. If no further two dimensional slices are required, at step S1311, data for the manufacture of the object is generated based upon the two dimensional images obtained at step S1308. The data format of the generated manufacturing data is dependent on the manufacturing process. For example, a manufacturing process may require a voxel based data format such as SVX, PNG, TIFF, JPG or PDF. The two dimensional slices may be encoded in the required data format using methods known in the art.

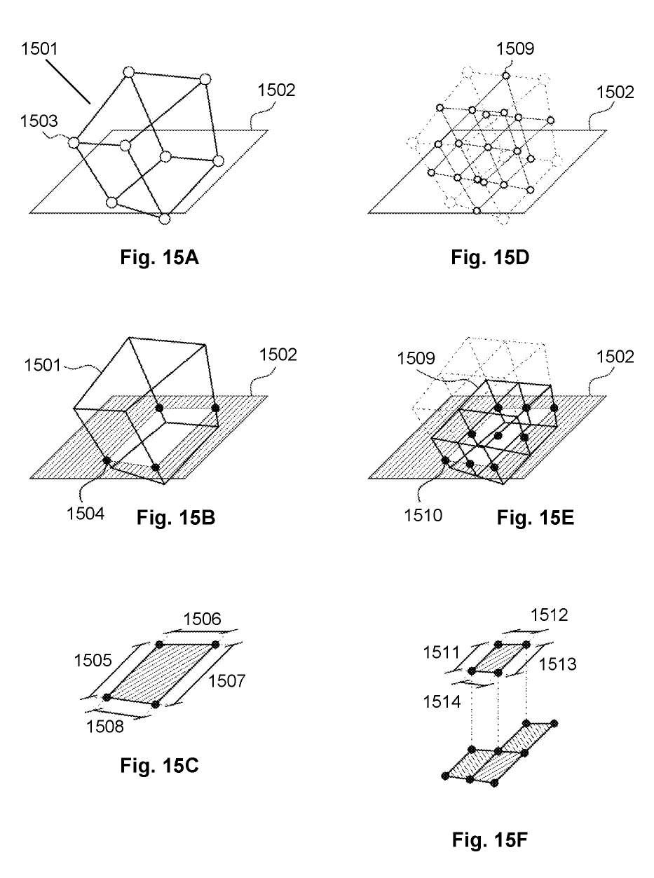

The processing of steps S1303-S1307 is described below with reference to FIGS. 15A to 15F.

FIG. 15A shows an exemplary voxel 1501 with a cutting plane 1502 below the voxel. As described above, each vertex 1503 of the voxel has corresponding (u, v, w) and (x, y, z) co-ordinates.

FIG. 15B illustrates a cutting plane 1502 moved to a position in which the cutting plane intersects the voxel at points highlighted by black circles 1504. The (x, y, z) co-ordinates of these intersecting points may be computed based upon the (x, y, z) co-ordinates of the vertices of the voxel.

As described above, at step S1304, a test is performed to determine if any of the intersecting voxels have a dimension that is larger than the fabrication resolution of the manufacturing process. This may, for example, be based upon a computed distance 1505, 1506, 1507, 1508 between each of the intersecting points as illustrated in FIG. 15C. If any distance is greater than the fabrication resolution, as described above with reference to step S1305, the voxel may be sub-divided as illustrated in FIG. 15D which shows sub-division of the voxel into eight uniform sub-voxels 1509.

As described above, at step S1303 the volumetric space is re-sliced with the cutting plane. FIG. 15E illustrates a cutting plane intersecting some of the sub-voxels illustrated in FIG. 15D at the points indicated by the black circles 1510. Processing passes to step S1304 to test the size of the intersecting sub-voxels which may be based upon the distances 1511, 1512, 1513, 1514 between intersecting points as shown in FIG. 15F.

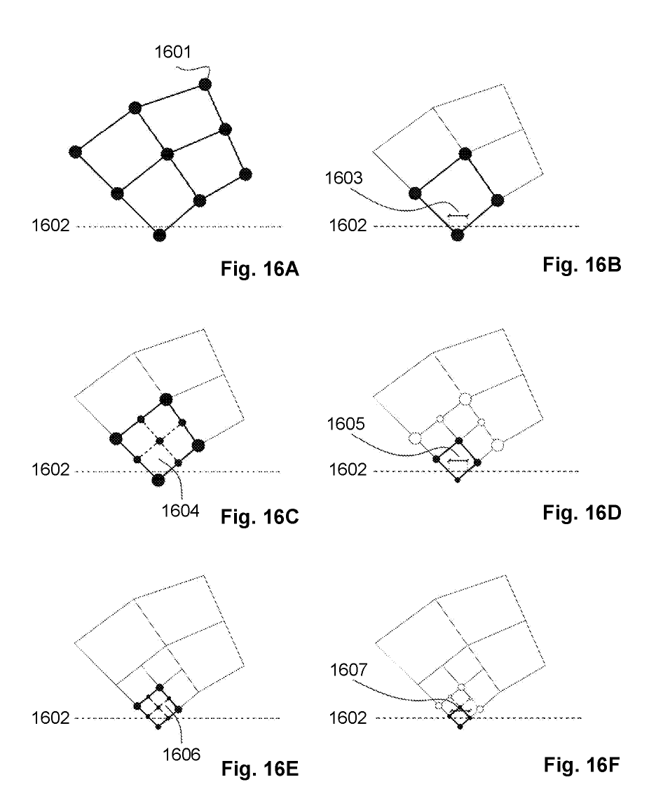

FIGS. 16A to 16F illustrates the processing of steps S1303-S1307 in a similar manner to FIG. 15 but in a side-on perspective.

FIG. 16A illustrates four exemplary voxels, with each vertex 1601 having a (u, v, w) co-ordinate and corresponding (x, y, z) co-ordinate. FIG. 16B illustrates the cutting plane 1602 intersecting a voxel and a comparison of the distance 1603 of the points of intersection with the fabrication resolution. In this case, the distance is larger than the fabrication resolution and FIG. 16C illustrates the sub-division of the voxel.

FIG. 16D illustrates the cutting plane intersecting a sub-voxel 1604 and a comparison of the distance 1605 of the points of intersection with the fabrication resolution. In this case, the distance is still larger than the fabrication resolution and FIG. 16E illustrates a further sub-division of the intersecting sub-voxel.

FIG. 16F illustrates the cutting plane intersecting a further sub-divided sub-voxel 1606 and a comparison of the distance 1607 of the points of intersection with the fabrication resolution. In this case, the distance is less than the fabrication resolution and therefore no further sub-division is required.

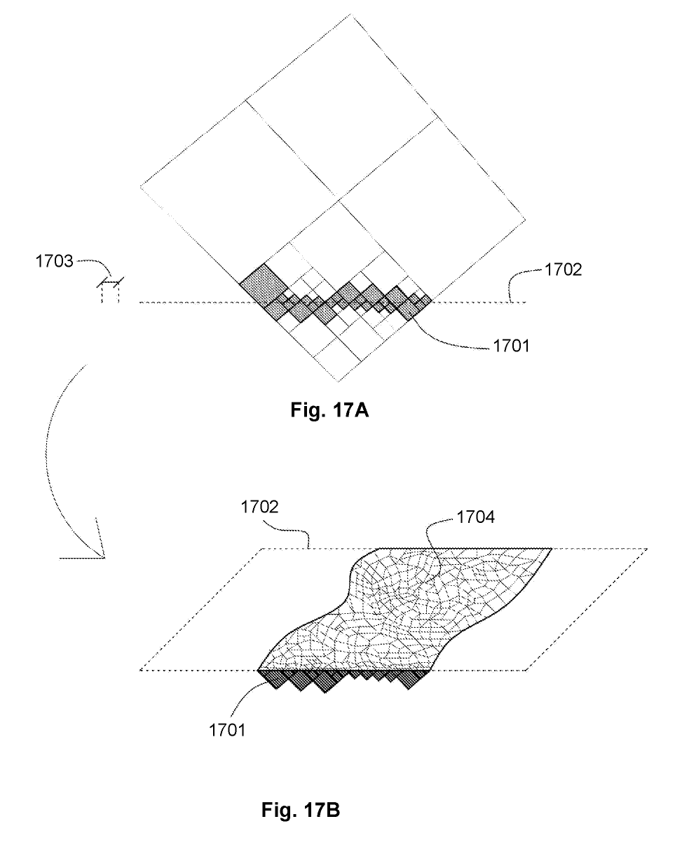

FIG. 17A shows another view in which the sub-division process has been completed. The resolution of the final sub-divided voxels 1701 intersecting the cutting plane 1702 is smaller than that of the manufacturing resolution 1703. FIG. 17B shows a cross sectional plane 1704 through intersecting voxels of FIG. 17A corresponding to the cross sectional plane generated at step S1308.

It will be appreciated that whilst it is described above that two dimensional images are generated at step S1308 and manufacturing data is generated based upon the generated two dimensional images at step S1311, in some embodiments machine instructions arranged to cause a manufacturing process to print a cross sectional plane of an object may be generated directly at step S1308. Alternatively, a representation of the object at the manufacturing resolution may be generated and machine instructions for a manufacturing process may be generated based upon the representation of the object. For example, in fusion deposition modelling, commonly known as “3D printing”, machine instructions for 3D printers may comprise a set of print head movements and commands for extruding material. Such instructions may be generated based upon the properties associated with the voxels intersecting the cutting plane.

The generated machine instructions generated according to the processing of FIG. 13 may take any convenient form. For example the machine instructions may be G-CODE instructions as will be understood in the art. Additionally or alternatively, machine instructions may be generated for subtractive manufacturing processes such as Computer Numerical Control (CNC) milling or machine instructions may be generated for the control of robotic assembly arms or for the control of manufacturing through assembly of small discrete parts to form larger objects.

In some manufacturing processes, manufacturing data in the form of a polygon model is used. A polygon model may be generated by discretizing the UVW shell into a three dimensional grid of voxels at a particular resolution. The outer faces of all voxels may then be converted into polygon faces to create a polygon mesh. Properties of polygon faces may be determined from the functional relationship between points in the UVW shell and the at least one property based upon a (u, v, w) co-ordinate associated with the polygon face. The (u, v, w) co-ordinate associated with the polygon face may for example, be the mid-point of the (u, v, w) co-ordinates of each vertex of the polygon face. Additionally or alternatively values of properties for each (u, v, w) vertex co-ordinate may be generated and the polygon faces of the polygon model may be generated based upon the properties at each vertex. For example, where the property is a colour, polygon faces of the polygon model may be generated using a vertex colouring algorithm. Geometric transformations such as Laplacian smoothing defined by the Geometric transformations property as previously discussed above may also be applied to the polygon model. The polygon model may then be exported to a data format such as OBJ, STL, VRML, AMF or X3D for manufacturing.

Where the surface comprises multiple discrete materials, a plurality of polygon models may be generated that are suitable for existing additive manufacturing methods. For example, a first polygon model may comprise only polygons with voxels corresponding to a first material. A second polygon model may comprise only polygons with voxels corresponding to a second material and so on. Manufacturing data may be generated for each polygon model and combined using software known in the art in order to manufacture parts having different materials.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1. A method of generating model data representing an object at a predetermined resolution, the method comprising:
receiving data representing a surface of the object, the data representing the surface of the object as a function of a first parameter and a second parameter;
receiving data defining a relationship between the first parameter, the second parameter and a third parameter, the third parameter defining a depth associated with the surface, and at least one property; wherein the data defining a relationship is encoded as a Compositional Pattern Producing Network;
wherein the first parameter, the second parameter and the third parameter define a volumetric space based upon the surface of the object;
generating the model data representing the object based upon the data defining a relationship, the data representing the surface of the object and the predetermined resolution.

2. The method of claim 1, wherein the surface of the object is represented as a Non-uniform rational B-spline surface.

3. The method of claim 1, wherein the data defining a relationship defines a relationship between the first, second and third parameters, and a fourth parameter and the at least one property.

4. The method of claim 3, wherein the fourth parameter is a parameter selected from the group consisting of: a parameter based upon a relationship between the first and second parameters:
a geometric property of the surface of the object; and
a parameter indicative of a curvature of the surface of the object.

5. (canceled)

6. (canceled)

7. The method of claim 3, wherein the first parameter, the second parameter, the third parameter and the fourth parameter defines the volumetric space based upon the surface of the object.

8. The method of claim 1, wherein the third parameter defining a depth associated with the surface is based upon a relationship between the surface and a second surface.

9. (canceled)

10. The method of claim 1, wherein the Compositional Pattern Producing Network is generated based upon an evolutionary algorithm.

11. The method of claim 1, wherein the at least one property is selected from the group consisting of: thickness, material, colour, topology and geometric transformation.

12. The method of claim 1, wherein the at least one property is a property associated with a plurality of values, wherein the property is determined based upon a probability associated with each of said plurality of values.

13. The method of claim 1, wherein generating the model data further comprises:
receiving values for the first, second and third parameters; and
processing the values based upon the relationship to obtain a value for the at least one property;
wherein the values for the first, second and third parameters are based upon the predetermined resolution.

14. (canceled)

15. The method of claim 1, further comprising generating manufacturing data based upon the generated model data.

16. The method of claim 15, wherein generating manufacturing data further comprises generating data representing a plurality of two dimensional cross-sections of the object based upon the model data.

17. The method of claim 15, wherein generating the model data comprises:
generating first model data based upon a first resolution;
generating a first cross section of the object based upon the first model data; and
processing the first cross section to generate model data at a second resolution;
wherein processing the first cross section to generate model data at a second resolution comprises:
determining a plurality of first voxels, each first voxel being associated with a point at which the object modelled at the first resolution is intersected by the cross section;
generating a plurality of second voxels, wherein each first voxel is associated with a plurality of second voxels; and
generating second model data based upon the plurality of second voxels;
wherein generating second model data based upon the plurality of second voxels comprises:
generating values of the first parameter, second parameter and third parameter based upon said plurality of second voxels; and
processing the generated values based upon the data defining a relationship between the first parameter, the second parameter and a third parameter to determine said at least one property associated with each of said voxels.

18. (canceled)

19. (canceled)

20. The method of claim 12, wherein the generated manufacturing data comprises data arranged to cause a manufacturing process to generate an object based upon the model data.

21. The method of claim 12, further comprising manufacturing an object based upon the manufacturing data.

22. The method of claim 1, further comprising generating the data representing a surface of the object.

23. The method of claim 1, further comprising:
receiving data representing a surface of a second object, the data representing the surface of the second object as a function of a first parameter and a second parameter;
generating model data representing the second object based upon the data defining a relationship, the data representing the surface of the second object and the predetermined resolution.

24. The method of claim 1, wherein the at least one property is generated based upon a probability associated with the property.

25. (canceled)

26. A non-transitory computer readable medium carrying a computer program to cause a computer carry out a method of generating model data representing an object at a predetermined resolution, the method comprising:
receiving data representing a surface of the object, the data representing the surface of the object as a function of a first parameter and a second parameter;
receiving data defining a relationship between the first parameter, the second parameter and a third parameter, the third parameter defining a depth associated with the surface, and at least one property; wherein the data defining a relationship is encoded as a Compositional Pattern Producing Network;
wherein the first parameter, the second parameter and the third parameter define a volumetric space based upon the surface of the object;
generating the model data representing the object based upon the data defining a relationship, the data representing the surface of the object and the predetermined resolution.

27. A computer apparatus for generating model data representing an object at a predetermined resolution comprising:
a memory storing processor readable instructions; and
a processor arranged to read and execute instructions stored in said memory;
wherein said processor readable instructions comprise instructions arranged to control the computer to carry out a method of generating model data representing an object at a predetermined resolution, the method comprising:
receiving data representing a surface of the object, the data representing the surface of the object as a function of a first parameter and a second parameter;
receiving data defining a relationship between the first parameter, the second parameter and a third parameter, the third parameter defining a depth associated with the surface, and at least one property; wherein the data defining a relationship is encoded as a Compositional Pattern Producing Network;
wherein the first parameter, the second parameter and the third parameter define a volumetric space based upon the surface of the object;
generating the model data representing the object based upon the data defining a relationship, the data representing the surface of the object and the predetermined resolution.
